(19) United States
(12) Patent Application Publication
(10) Pub. No.: US 2010/0293823 A1
(43) Pub. Date: Nov. 25, 2010

(54) POSTCARD

(75) Inventor: YU-TSWAN HSU, Taipei County (TW)

Correspondence Address: TROP, PRUNER & HU, P.C., 1616 S. VOSS ROAD, SUITE 750, HOUSTON, TX, 77057-2631, US

(73) Assignee: Golden Image Art Company

(21) Appl. No.: 12/469,750

(22) Filed: May 21, 2009

(51) Int. Cl. G09F 1/06

(52) U.S. Cl. 40/124.191

(57) ABSTRACT

A postcard includes: a front postcard panel having first and second surfaces, the first surface having a stamp, address, and message-writing regions; and a rear postcard panel attached to the second surface of the front postcard panel and including at least one stand cutout that is releasably adhered to the second surface of the front postcard panel and that is detachable from the remainder of the rear postcard panel and the second surface of the front postcard panel.

### BACKGROUND OF THE INVENTION

1. Field of the Invention

The invention relates to a postcard, more particularly to a postcard having a front postcard panel and a rear postcard panel releasably adhered to the front postcard panel.

2. Description of the Related Art

Taiwan Utility Model No. M310124 discloses a postcard that has a printed pattern and a foldable portion. The foldable portion can be folded so that the printed pattern is formed into a 3D (three-dimensional) structure.

### SUMMARY OF THE INVENTION

An object of the present invention is to provide a postcard that is attractive and that has a stand cutout that may be formed into a 3D structure.

According to the present invention, there is provided a postcard that comprises: a front postcard panel having first and second surfaces, the first surface having a stamp region, an address region, and a message-writing region; and a rear postcard panel attached to the second surface of the front postcard panel and including at least one stand cutout that is releasably adhered to the second surface of the front postcard panel and that is detachable from the remainder of the rear postcard panel and the second surface of the front postcard panel.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic front view of the preferred embodiment of a postcard according to the present invention;

FIG. 2 is a schematic rear view of the preferred embodiment;

FIG. 3 is a schematic view to illustrate how stand cutouts of a rear postcard panel are detached from a front postcard panel of the preferred embodiment;

FIG. 4 is a fragmentary sectional view to illustrate a layered structure of the preferred embodiment; and

FIG. 5 is an assembled perspective view to illustrate how the stand cutouts are assembled into a decorative object.

### DETAILED DESCRIPTION OF THE PREFERRED EMBODIMENT

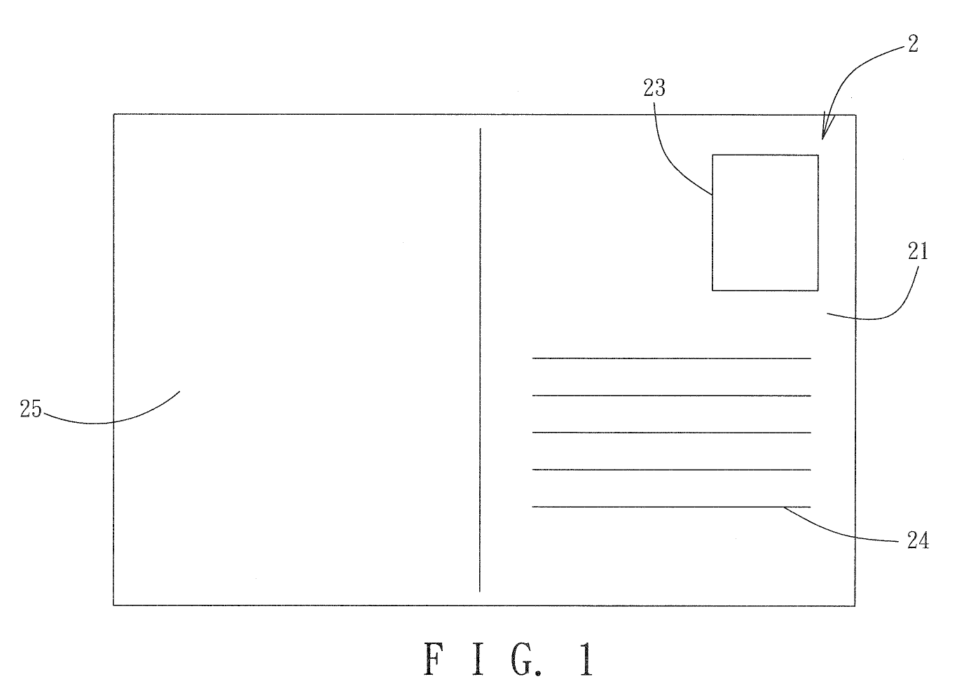

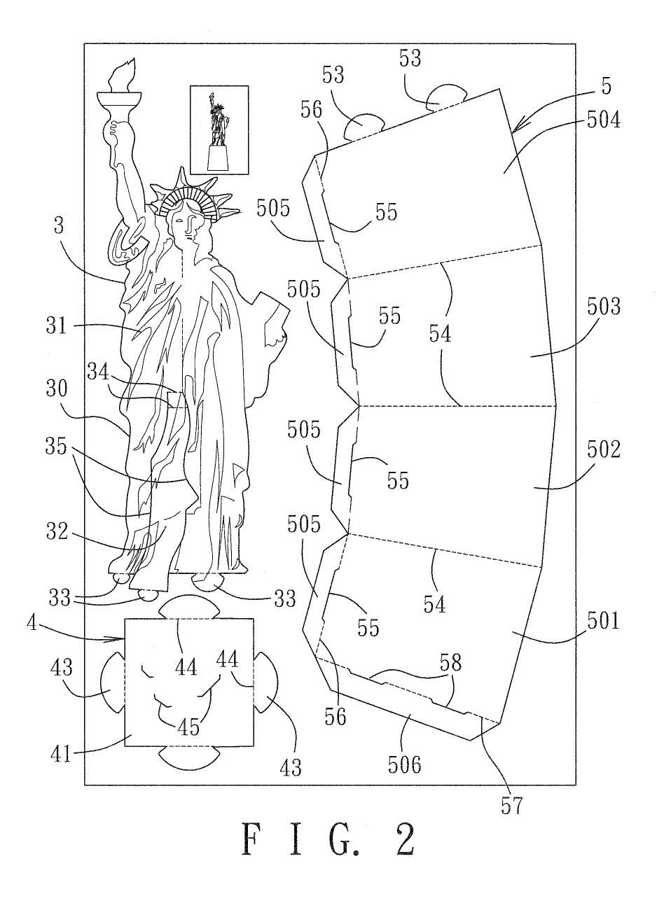

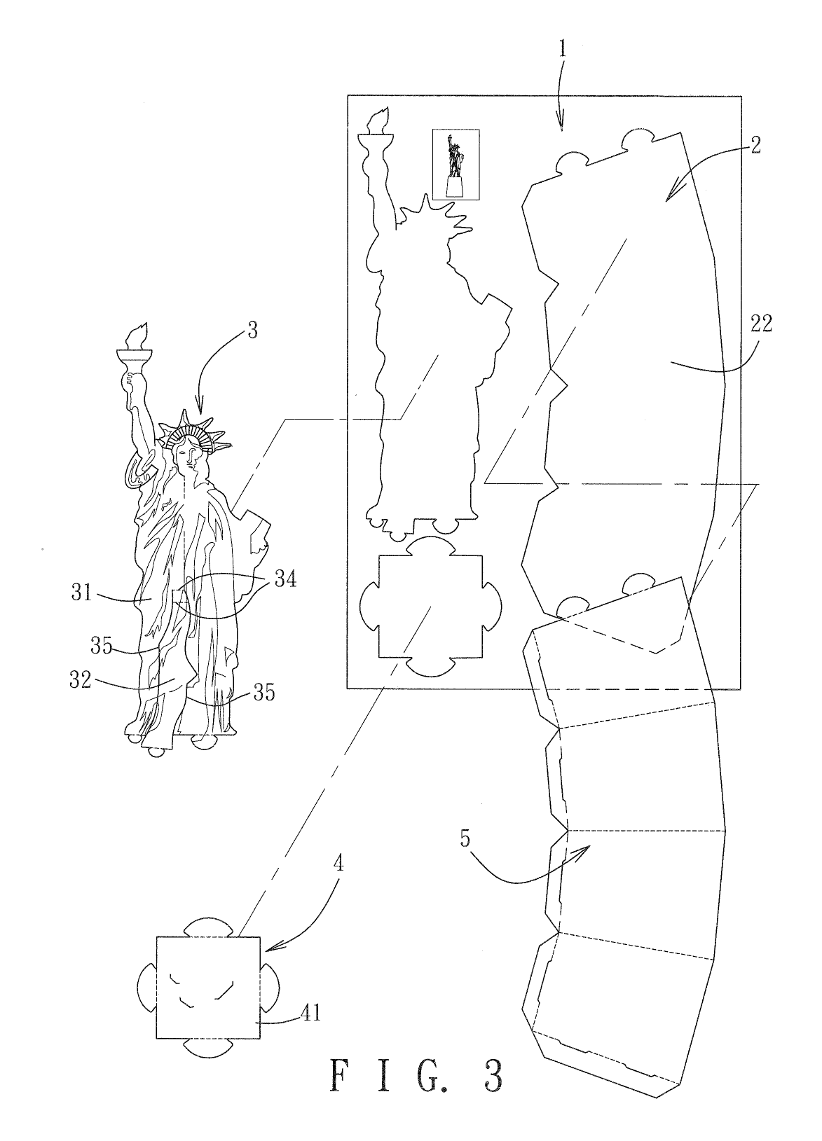

Referring to FIGS. 1 to 5, the preferred embodiment of a postcard according to the present invention is shown to include: a front postcard panel 2 having opposite first and second surfaces 21, 22, the first surface 21 having a stamp region 23, an address region 24, and a message-writing region 25; and a rear postcard panel 1 attached to the second surface 22 of the front postcard panel 2 and including first, second and third stand cutouts 3, 4, 5 that are releasably adhered to the second surface 22 of the front postcard panel 2 and that are detachable from the remainder of the rear postcard panel 1 and the second surface 22 of the front postcard panel 2.

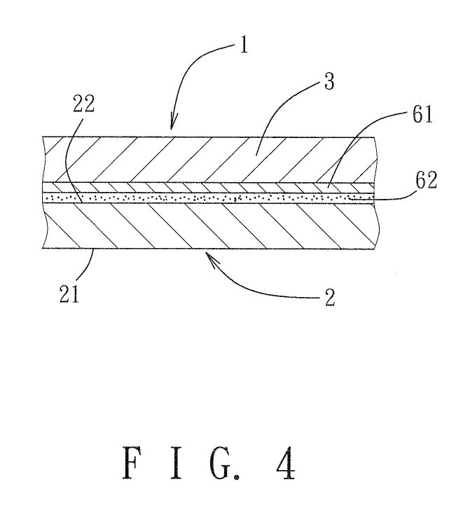

In this embodiment, each of the first, second and third stand cutouts 3, 4, 5 is provided with a smooth layer 61 of a release material (only the smooth layer 61 of the release material of the first stand cutout 3 is shown in FIG. 4 for the sake of brevity). The second surface 22 of the front postcard panel 2 is provided with an adhesive 62 bonded to the smooth layer 61 of the release material on each of the first, second and third stand cutouts 3, 4, 5. The release material is preferably silicone.

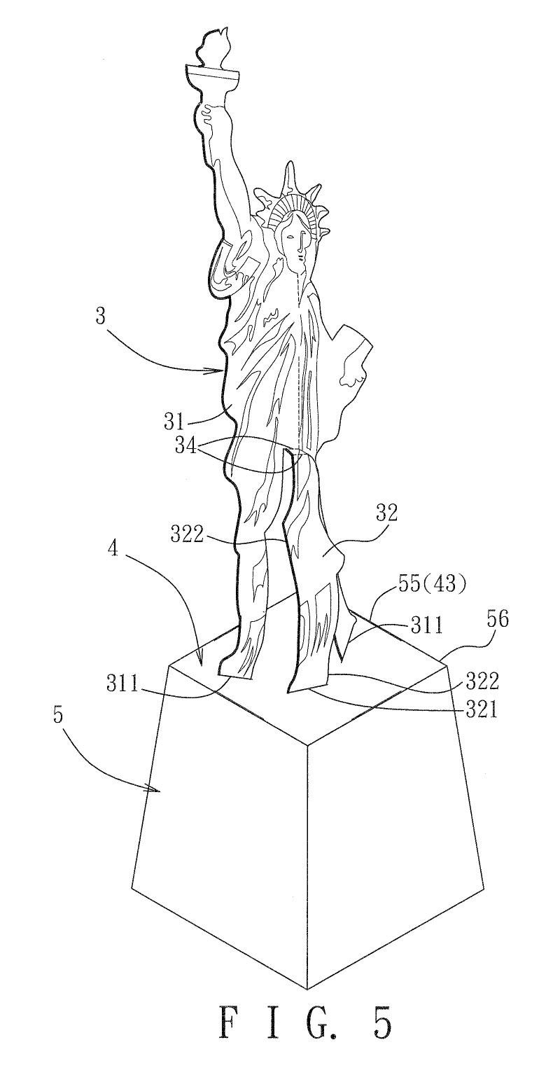

In this embodiment, the first stand cutout 3 is formed into a particular pattern, and has a boundary 30, two fold lines 34 disposed within the boundary 30, two tear lines 35 extending respectively from two opposite ends of one of the fold lines 34 to the boundary 30 of the first stand cutout 3, and first and second portions 31, 32 divided by said one of the fold lines 34 and the tear lines 35. The first stand cutout 3 is foldable along the fold lines 34 when the stand cutout 3 is torn along the tear lines 35 so as to permit the first and second portions 31, 32 of the first stand cutout 3 to be disposed on different planes (see FIG. 5).

The first portion 31 of the stand cutout 3 has two lower ends 311. The second portion 32 of the stand cutout 3 has a lower end 321 and two opposite sides 322. The two opposite sides 322 of the second portion 32 are separated from the first portion 31 along the tear lines 35 when the stand cutout 3 is torn along the tear lines 35. The lower end 321 of the second portion 32 of the first stand cutout 3 is substantially coplanar with the lower ends 311 of the first portion 31, and the first stand cutout 3 is configured to have a decorative 3D patterned structure when the first stand cutout 3 is torn along the tear lines 35 and when the first stand cutout 3 is folded along the fold lines 34. Each of the ends 311, 321 of the first and second portions 31, 32 of the first stand cutout 3 has an insert tab 33 protruding therefrom.

The second stand cutout 4 has a rectangular base portion 41, four insert tabs 43 protruding respectively from four sides of the base portion 41, four slits 45, and four fold lines 44. Each of the fold lines 44 divides the base portion 41 and a respective one of the insert tabs 43, and permits the second stand cutout 4 to be foldable therealong. Each of the slits 45 is formed in the base portion 41.

The third stand cutout 5 has first, second, third and fourth portions 501, 502, 503, 504, four first flaps 505, a second flap 506, three first fold lines 54, four second fold lines 56, a third fold line 57, four first slits 55, two second slits 58, and two insert tabs 53. Each of the first fold lines 54 divides two adjacent ones of the first, second, third and fourth portions 501, 502, 503, 504 of the third stand cutout 5. The first flaps 55 are connected to the first, second, third and fourth portions 501, 502, 503, 504 of the third stand cutout 5, respectively. Each of the second fold lines 56 divides a respective one of the first, second, third and fourth portions 501, 502, 503, 504 of the third stand cutout 5 and a respective one of the first flaps 505. The second flap 506 is connected to the first portion 501 of the third stand cutout 5. The third fold line 57 divides the second flap 506 and the first portion 501 of the third stand cutout 5. Each of the first slits 55 extends along a respective one of the second fold lines 56. The second slits 58 extend along different sections of the third fold line 57, respectively. The insert tabs 53 protrude from the fourth portion 504 of the third stand cutout 5, and extend respectively through the second slits 58 when the third stand cutout 5 is folded along the first, second and third fold lines 54, 56, 57 so as to form the third stand cutout 5 into a 3D stand structure (see FIG. 5).

In assembly, the third stand cutout 5 is first formed into the 3D stand structure, the second stand cutout 4 is then folded along the fold lines 44, and the insert tabs 43 of the second stand cutout 4 are subsequently extended through the first slits 55 in the third stand cutout 5, respectively, so as to form the second stand cutout 4 into a platform on the 3D stand structure. The 3D patterned structure of the first stand cutout 3 is then mounted to the platform of the second stand cutout 4 by extending the insert tabs 33 of the first stand cutout 3 through the slits 45 in the second stand cutout 4, respectively.

With the inclusion of at least one of the first, second and third stand cutouts 3, 4, 5 in the postcard of this invention, the postcard can be separated into a front postcard panel 2 and a decorative 3D patterned structure. This allows the front postcard panel 2 to be left intact, and makes the postcard more attractive.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A postcard comprising:
a front postcard panel having first and second surfaces, said first surface having a stamp region, an address region, and a message-writing region; and
a rear postcard panel attached to said second surface of said front postcard panel and including at least one stand cutout that is releasably adhered to said second surface of said front postcard panel and that is detachable from the remainder of said rear postcard panel and said second surface of said front postcard panel.

2. The postcard of claim 1, wherein said stand cutout is provided with a smooth layer of a release material, said second surface of said front postcard panel being provided with an adhesive bonded to said smooth layer of said release material on said stand cutout.

3. The postcard of claim 2, wherein said release material is silicone.

4. The postcard of claim 1, wherein said stand cutout has a boundary, a fold line disposed within said boundary, two tear lines extending respectively from two opposite ends of said fold line to said boundary of said stand cutout, and first and second portions divided by said fold line and said tear lines, said stand cutout being foldable along said fold line when said stand cutout is torn along said tear lines so as to permit said first and second portions of said stand cutout to be disposed on different planes.

5. The postcard of claim 4, wherein said first portion of said stand cutout has an end, said second portion of said stand cutout having an end and two opposite sides, said two opposite sides being separated apart from said first portion along said tear lines when said stand cutout is torn along said tear lines, said end of said second portion being substantially coplanar with said end of said first portion when said stand cutout is torn along said tear lines and when said stand cutout is folded along said fold line.

6. The postcard of claim 1, wherein said stand cutout has a plurality of portions, a flap, a plurality of fold lines, at least one slit, and at least one insert tab, said flap connected to one of said portions of said stand cutout, said insert tab protruding from another one of said portions of said stand cutout, one of said fold lines dividing said flap and said one of said portions of said stand cutout, the remainder of said fold lines dividing two adjacent ones of said portions of said stand cutout, said slit extending along said one of said fold lines, said insert tab extending through said slit when said stand cutout is folded along said fold lines so as to form the stand cutout into a 3D structure.
